(19) United States
(12) Patent Application Publication
(10) Pub. No.: US 2002/0169967 A1
(43) Pub. Date: Nov. 14, 2002

(54) Method and apparatus for multiple token access to thin client architecture session

(76) Inventors: Sangeeta Varma, Sunnyvale, CA (US); Shivaputrappa S. Vibhuti, Sunnyvale, CA (US)

Correspondence Address: J.D. Harriman II, COUDERT BROTHERS, 23rd Floor, 333 South Hope Street, Los Angeles, CA, 90071, US

(21) Appl. No.: 09/858,017

(22) Filed: May 14, 2001

(51) Int. Cl. H04K 1/00

(52) U.S. Cl. 713/185

(57) ABSTRACT

Embodiments of the present invention are directed to a method and apparatus for multiple token access to thin client architecture session. In one embodiment, a user is associated with a session using an authenticated token. A user may access a session by authenticating the user's identity. An authenticated token for the user is created and the user is granted access to the session. As a result, the user will be able to access the session without the physical token by authenticating the user's identity using a passphrase or biometric identifier. In one embodiment, a user is able to access a session from one terminal when the session is already being accessed from another terminal. The user presents an authenticated token associated with the session, and the session is disconnected from the old terminal and input and output information is rerouted to the new terminal.

### BACKGROUND OF THE INVENTION

1. Field of the Invention

The present invention relates to the field of computer network access, and in particular to a method and apparatus for multiple token access to thin client architecture session.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

When computing in a thin client architecture (e.g., a SunRay system), users access a session by presenting a physical token to the system. Typically, the physical token is a smart card. The user is able to access the same session from any terminal on the system as long as the user presents the same physical token. This enables the user to leave an active session started on one terminal, move to another terminal, present the physical token and resume work in the session where the user left off. However, if the user temporarily or permanently loses the physical token, the user is unable to access the active session. This problem can be better understood by a review of multi-tier application architecture.

Multi-Tier Application Architecture

In the multi-tier application architecture, a client communicates requests to a server for data, software and services, for example, and the server responds to the requests. The server's response may entail communication with a database management system for the storage and retrieval of data.

The multi-tier architecture includes at least a database tier that includes a database server, an application tier that includes an application server and application logic (i.e., software application programs, functions, etc.), and a client tier. The data base server responds to application requests received from the client. The application server forwards data requests to the database server.

FIG. 1 provides an overview of a multi-tier architecture. Client tier 100 typically consists of a computer system that provides a graphic user interface (GUI) generated by a client 110, such as a browser or other user interface application. Conventional browsers include Internet Explorer and Netscape Navigator, among others. Client 110 generates a display from, for example, a specification of GUI elements (e.g., a file containing input, form, and text elements defined using the Hypertext Markup Language (HTML)) and/or from an applet (i.e., a program such as a program written using the Java™ programming language, or other platform independent programming language, that runs when it is loaded by the browser).

Further application functionality is provided by application logic managed by application server 120 in application tier 130. The apportionment of application functionality between client tier 100 and application tier 130 is dependent upon whether a “thin client” or “thick client” topology is desired. In a thin client topology, the client tier (i.e., the end user's computer) is used primarily to display output and obtain input, while the computing takes place in other tiers. A thick client topology, on the other hand, uses a more conventional general purpose computer having processing, memory, and data storage abilities. Database tier 140 contains the data that is accessed by the application logic in application tier 130. Database server 150 manages the data, its structure and the operations that can be performed on the data and/or its structure.

Application server 120 can include applications such as a corporation's scheduling, accounting, personnel and payroll applications, for example. Application server 120 manages requests for the applications that are stored therein. Application server 120 can also manage the storage and dissemination of production versions of application logic. Database server 150 manages the database(s) that manage data for applications. Database server 150 responds to requests to access the scheduling, accounting, personnel and payroll applications' data, for example.

Connection 160 is used to transmit data between client tier 100 and application tier 130, and may also be used to transfer the application logic to client tier 100. The client tier can communicate with the application tier via, for example, a Remote Method Invocator (RMI) application programming interface (API) available from Sun Microsystems™. The RMI API provides the ability to invoke methods, or software modules, that reside on another computer system. Parameters are packaged and unpackaged for transmittal to and from the client tier. Connection 170 between application server 120 and database server 150 represents the transmission of requests for data and the responses to such requests from applications that reside in application server 120.

Elements of the client tier, application tier and database tier (e.g., client 110, application server 120 and database server 150) may execute within a single computer. However, in a typical system, elements of the client tier, application tier and database tier may execute within separate computers interconnected over a network such as a LAN (local area network) or WAN (wide area network).

Sessions

Users interact with the system through a session. A system may have multiple sessions active at one time, and each session is devoted to one user. Each client presents a physical token (e.g., a smart card) to initiate a session. In thin client architectures, the session is maintained on a server and accessed through a terminal. Since the server maintains all of the state information for a session, the user may change terminals by presenting the physical token to a different token without losing the work done in a session at the previous terminal. Output and input for the session is simply redirected to the new location of the physical token.

For example, a user may be accessing a session, perhaps to compose a document, from a terminal in the user's office. The user could continue to work on the document from another terminal in the cafeteria during lunch by removing the physical token from the terminal in the office and presenting the physical token to a terminal in the lunch room. The session resumes exactly where the user left off.

A user is also able to leave a session and later resume the same session where the user left off by presenting the physical token without switching terminals. For example, a user may be working on a document from a terminal in the user's office. The user can remove the physical token and go home for the night. The user can return to work in the morning (or after any amount of time) and present the physical token to the terminal in the user's office to resume the session where the user left off.

Missing Physical Token

A problem arises when the users wishes to access a session but does not have the physical token associated with the session. In the examples above, the user may discover upon reaching the cafeteria that the physical token is still in the user's office or the user may discover upon returning to work that the physical token is still at the user's home. In prior art systems, the user is unable to access the desired session. Instead, the user must either retrieve the physical token or locate a system administrator who can enable the user to access the session.

In some situations, neither retrieving the physical token nor locating a system administrator are feasible solutions. For example, the user wishes to access a session before a meeting, but the user does not currently have the physical token, the meeting begins in five minutes and both retrieving the physical token and locating an administrator would require more than five minutes.

### SUMMARY OF THE INVENTION

Embodiments of the present invention are directed to a method and apparatus for multiple token access to thin client architecture session. In one embodiment, a user is associated with a session using an authenticated token. A user may access a session by authenticating the user's identity. An authenticated token for the user is created and the user is granted access to the session. In one embodiment, the user presents a physical token (e.g., smart cards) and then authenticates the user's identity to produce the authenticated token. In another embodiment, the user presents a mobile GUI login token and then authenticates the user's identity to produce the authenticated token.

Authenticated tokens may be presented to the system after a user completes an authentication process. In one embodiment, the user must present a passphrase to authenticate the user's identity. In another embodiment, a biometric identifier is used to authenticate the user's identity. In one embodiment, the user's fingerprint pattern is as a form of biometric identification. In another embodiment, the user's retinal image is scanned as a form of biometric identification. As a result, the user will be able to access the session without the physical token by authenticating the user's identity using the passphrase or biometric identifier. In one embodiment, a non-authenticated token creates a new session.

In one embodiment, a user is able to access a session from one terminal when the session is already being accessed from another terminal. The user presents an authenticated token associated with the session, either by presenting physical token and authenticating the user's identity or by another user identification authentication method, and the session is disconnected from the old terminal and input and output information is rerouted to the new terminal.

### BRIEF DESCRIPTION OF THE DRAWINGS

These and other features, aspects and advantages of the present invention will become better understood with regard to the following description, appended claims and accompanying drawings where:

FIG. 1 is a block diagram of a multi-tier architecture.

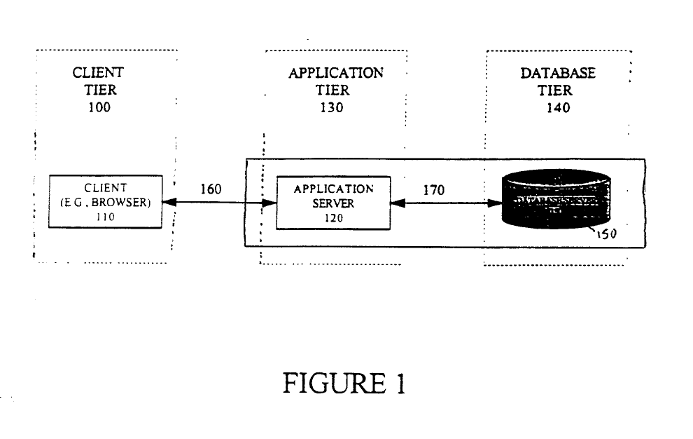

FIG. 2 is a flow diagram of the process of accessing a session according to one embodiment of the present invention.

FIG. 3 is a flow diagram of the process of accessing a session after authenticating the user's identity in accordance with one embodiment of the present invention.

FIG. 4 is a block diagram of a mapping of initial tokens to authenticated tokens in accordance with one embodiment of the present invention.

FIG. 5 is a flow diagram of the process of accessing a connected session from another terminal in accordance with one embodiment of the present invention.

FIG. 6 is a block diagram of an example of a thin client topology called a virtual desktop system architecture in accordance with one embodiment of the present invention.

FIG. 7 is a block diagram of a system wherein one or more services communicate with one or more HIDs through a communication link such as network in accordance with one embodiment of the present invention.

FIG. 8 is a block diagram of an example embodiment of the HID in accordance with one embodiment of the present invention.

FIG. 9 is a block diagram of a single chip implementation of an HID in accordance with one embodiment of the present invention.

### DETAILED DESCRIPTION OF THE INVENTION

The invention is a method and apparatus for multiple token access to thin client architecture session. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

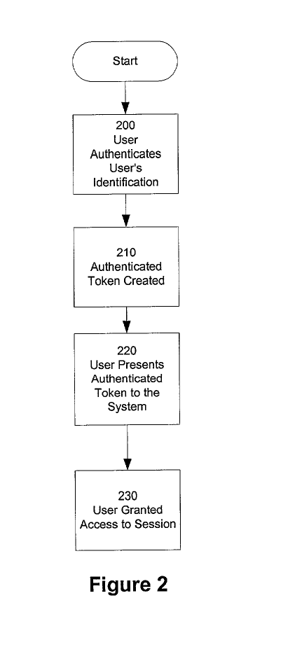

In one embodiment, a user is associated with a session using an authenticated token. A user may access a session by authenticating the user's identity. An authenticated token for the user is created and the user is granted access to the session. FIG. 2 illustrates the process of accessing a session according to one embodiment of the present invention. At step 200, a user authenticates the user's identification. At step 210, an authenticated token is created. At step 220, the user presents the authenticated token to the system. At step 230, the user is granted access to the session associated with the authenticated user.

In one embodiment, the user presents a physical token (e.g., smart cards) and then authenticates the user's identity to produce the authenticated token. In another embodiment, the user presents a mobile GUI login token and then authenticates the user's identity to produce the authenticated token. Authenticated tokens may be presented to the system after a user completes an authentication process.

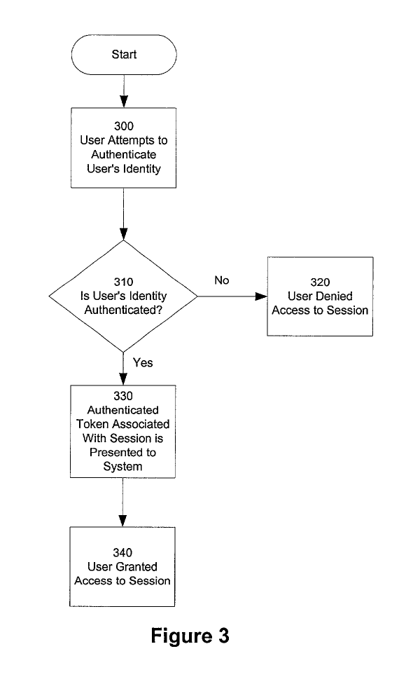

FIG. 3 illustrates the process of accessing a session after authenticating the user's identity in accordance with one embodiment of the present invention. At step 300, a user attempts to authenticate the user's identity. In one embodiment, the user must present a passphrase to authenticate the user's identity. In another embodiment, a biometric identifier is used to authenticate the user's identity. In one embodiment, the user's fingerprint pattern is scanned. In another embodiment, the user's retinal image is scanned. In yet another embodiment, the presence of a physical token authenticates the user's identity.

At step 310, it is determined whether the user's identity is authenticated. If the user's identity is not authenticated, at step 320, the user is denied access to the session. If the user's identity is authenticated, at step 330, an authenticated token associated with the session is presented to the system. At step 340, the user is granted access to the session.

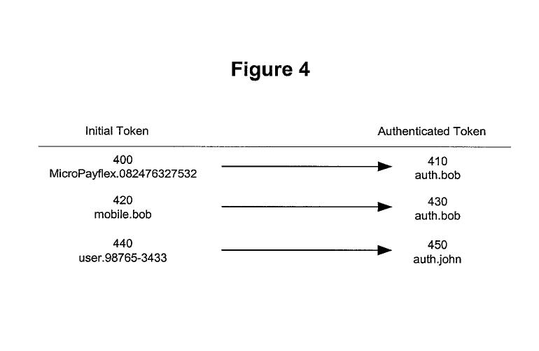

In one embodiment, initial tokens are converted to authenticated tokens. For example, a physical token converts to an authenticated token after the user's identity is authenticated. FIG. 4 illustrates a conversion of initial tokens to authenticated tokens in accordance with one embodiment of the present invention. A user, bob, presents an initial token of MicroPayflex.082476327532 400 by presenting a micropayflex card. The user authenticates his identity and the initial token converts to the authenticated token auth.bob 410. Similarly, a user, bob, presents an initial token of mobile.bob 420 by presenting a Non-Sc mobility login GUI. The user authenticates his identity and the initial token converts to the authenticated token auth.bob 430. A user, john, presents an initial token of user.98765-3433 440 by presenting a registered CyberflexAccess card. The user authenticates his identity and the initial token converts to auth.john 450.

Presenting the token MicroPayflex.082476327532 or mobile.bob and authenticating user bob's identity results in the authenticated token auth.bob being presented to the system. A user may use either MicroPayflex.082476327532 or mobile.bob with authentication to access the same session. However, the token user.98765-3433 and authenticating user john's identity results in a different authenticated token and will not allow the user to access the session associated with auth.bob.

In one embodiment, a non-authenticated token creates a new session. Thus, a user can have one authenticated session running concurrently with multiple non-authenticated sessions.

In one embodiment, a user is able to access a session from one terminal when the session is already being accessed from another terminal. The user presents an authenticated token associated with the session, either by presenting an associated physical token and authenticating the user's identity or by another user identification authentication method. The session is disconnected from the old terminal and input and output information is rerouted to the new terminal.

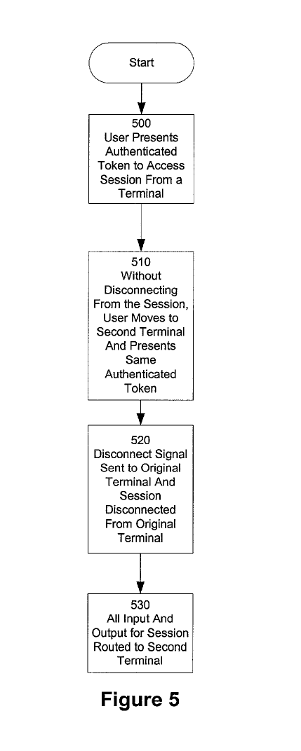

FIG. 5 illustrates the process of accessing a connected session from another terminal in accordance with one embodiment of the present invention. At step 500, the user presents an authenticated token to access a session from a terminal. At step 510, without disconnecting from the session, the user moves to a second terminal and presents the same authenticated token. At step 520, a disconnect signal is sent to the original terminal, and the session is disconnected from the original terminal. At step 530, all input and output for the session is routed to the second terminal.

Virtual Desktop System Architecture

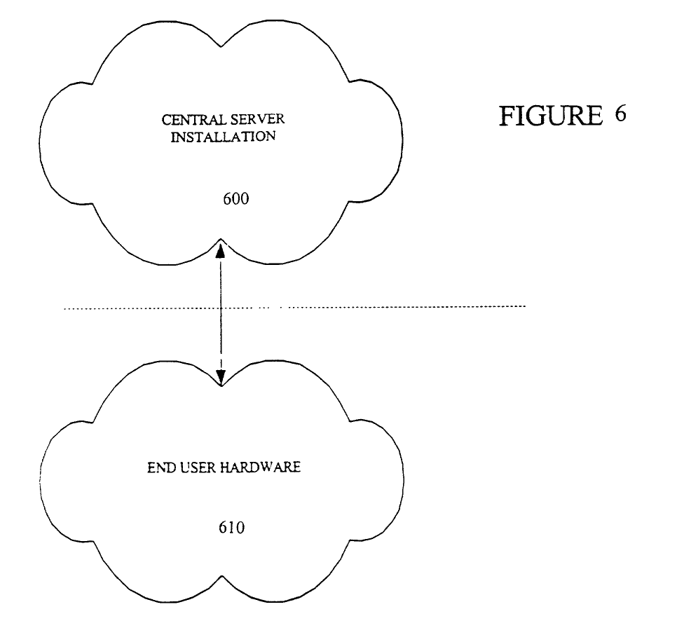

FIG. 6 shows an example of a thin client topology called a virtual desktop system architecture. The virtual desktop system architecture provides a re-partitioning of functionality between a central server installation 600 and end user hardware 610. Data and computational functionality are provided by data sources via a centralized processing arrangement. At the user end, all functionality is eliminated except that which generates output to the user (e.g., display and speakers), takes input from the user (e.g., mouse and keyboard) or other peripherals that the user may interact with (e.g., scanners, cameras, removable storage, etc.). All computing is done by the central data source and the computing is done independently of the destination of the data being generated. The output of the source is provided to a terminal, referred to here as a “Human Interface Device” (HID). The HID is capable of receiving the data and displaying the data.

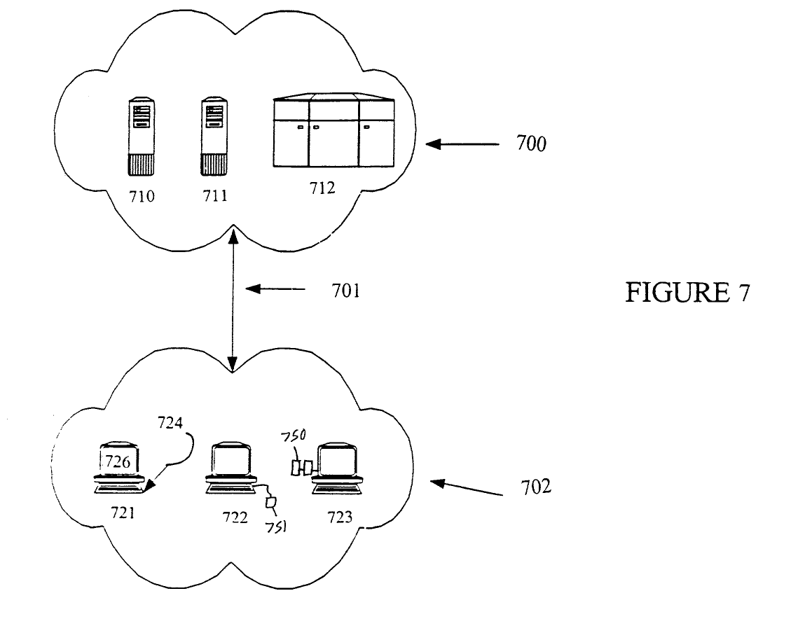

The functionality of the virtual desktop system is partitioned between a display and input device such as a remote system and associated display device, and data sources or services such as a host system interconnected to the remote system via a communication link. The display and input device is a human interface device (HID). The system is partitioned such that state and computation functions have been removed from the HID and reside on data sources or services. One or more services communicate with one or more HIDs through a communication link such as network. An example of such a system is illustrated in FIG. 7, wherein the system comprises computational service providers 700 communicating data through communication link 701 to HIDs 702.

The computational power and state maintenance are provided by the service providers or services. The services are not tied to a specific computer, but may be distributed over one or more traditional desktop systems such as described in connection with FIG. 7, or with traditional servers. One computer may have one or more services, or a service may be implemented by one or more computers. The service provides computation, state and data to HIDs and the service is under the control of a common authority or manager. In FIG. 7, the services are provided by computers 710, 711, and 712. In addition to the services, a central data source can provide data to the HIDs from an external source such as for example the Internet or world wide web. The data source can also be broadcast entities such as those that broadcast data (e.g., television and radio signals).

Examples of services include X11/Unix services, archived or live audio or video services, Windows NT service, Java™ program execution service and others. A service herein is a process that provides output data and response to user requests and input. The service handles communication with an HID currently used by a user to access the service. This includes taking the output from the computational service and converting it to a standard protocol for the HID. The data protocol conversion is handled by a middleware layer, such as the X11 server, the Microsoft Windows interface, video format transcoder, the OpenGL® interface, or a variant of the java.awt.graphics class within the service producer machine. The service machine handles the translation to and from a virtual desktop architecture wire protocol described further below.

Each service is provided by a computing device optimized for its performance. For example, an Enterprise class machine could be used to provide X11/Unix service, a Sun MediaCenterm could be used to provide video service, a Hydra based NT machine could provide applet program execution services.

The service providing computer system can connect directly to the HIDs through the interconnect fabric. It is also possible for the service producer to be a proxy for another device providing the computational service, such as a database computer in a three-tier architecture, where the proxy computer might only generate queries and execute user interface code.

The interconnect fabric can comprise any of multiple suitable communication paths for carrying data between the services and the HIDs. In one embodiment the interconnect fabric is a local area network implemented as an Ethernet network. Any other local network may also be utilized. The invention also contemplates the use of wide area networks, the Internet, the world wide web, and others. The interconnect fabric may be implemented with a physical medium such as a wire or fiber optic cable, or it may be implemented in a wireless environment.

The interconnect fabric provides actively managed, low-latency, high-bandwidth communication between the HID and the services being accessed. One embodiment contemplates a single-level, switched network, with cooperative (as opposed to completing) network traffic. Dedicated or shared communications interconnects maybe used in the present invention.

The HID is the means by which users access the computational services provided by the services. FIG. 7 illustrates HIDs 721, 722 and 723. Each HID comprises a display 726, a keyboard 724, mouse 751, and audio speakers 750. The HID includes the electronics need to interface these devices to the interconnection fabric and to transmit to and receive data from the services.

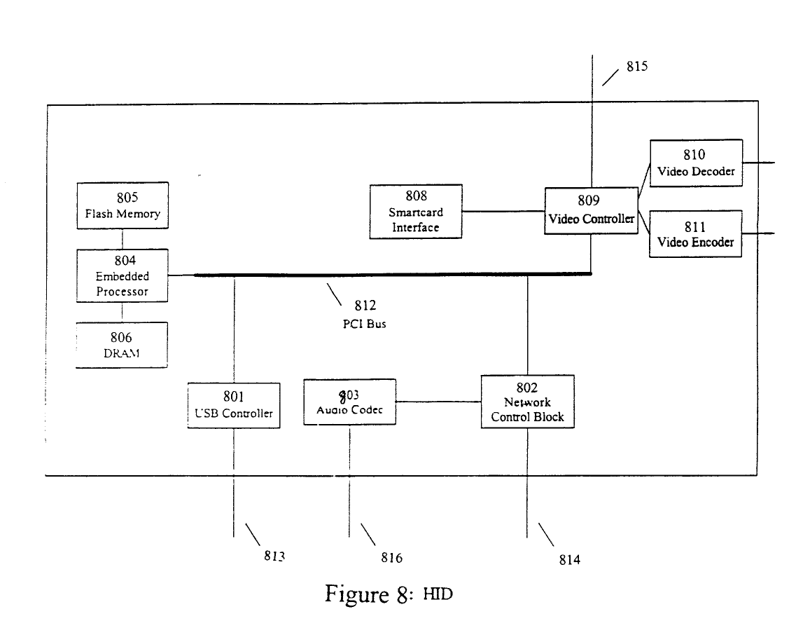

A block diagram of an example embodiment of the HID is illustrated in FIG. 8. The components of the HID are coupled internally to a PCI bus 812. Network control block 802 communicates to the interconnect fabric, such as an Ethernet, through line 814. An audio codec 803 receives audio data on interface 816 and is coupled to network control block 802. USB data communication is provided on lines 813 to a USB controller 801. The HID further comprises a embedded processor 804 such as a Sparc2ep with coupled flash memory 805 and DRAM 806. The USB controller 801, the network control block 802 and the embedded processor 804 are all coupled to the PCI bus 812. A video controller 809, also coupled to the PCI bus 812, can include an ATI RagePro+frame buffer controller which provides SVGA output on the line 815. NTSC data is provided in and out of the video controller through video decoder 810 and encoder 811 respectively. A smartcard interface 808 may also be coupled to the video controller 809.

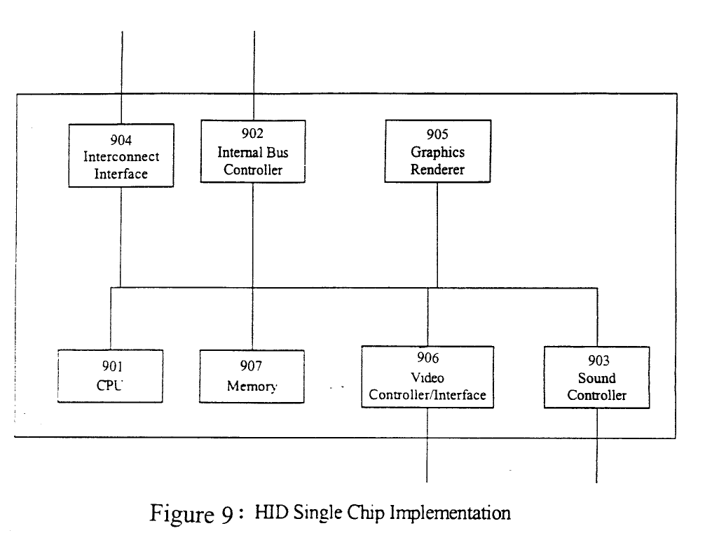

Alternatively, the HID can comprise a single chip implementation as illustrated in FIG. 9. The single chip includes the necessary processing capability implemented via CPU 901 and graphics renderer 905. Chip memory 907 is provided, along with video controller/interface 906. A internal bus (USB) controller 902 is provided to permit communication to a mouse, keyboard and other local devices attached to the HID. A sound controller 903 and interconnect interface 904 are also provided. The video interface shares memory 907 with the CPU 901 and graphics renderer 905. The software used in this embodiment may reside locally in on-volatile memory or it can be loaded through the interconnection interface when the device is powered.

The operation of the virtual desktop system architecture is described in copending U.S. patent application Ser. No. 09/063,335, filed Apr. 20, 1998, entitled “Method and Apparatus for Providing A Virtual Desktop System Architecture” and assigned to the present assignee, and incorporated herein by reference.

Thus, a method and apparatus for multiple token access to thin client architecture session is described in conjunction with one or more specific embodiments. The invention is defined by the following claims and their full scope and equivalents.

1. A method for accessing a session comprising:
associating a user with said session; and
presenting an authenticated token to access said session from a first terminal.

2. The method of claim 1 further comprising:
presenting said authenticated token to access said session from a second terminal.

3. The method of claim 2 further comprising:
sending a session disconnect signal to said first terminal; and
routing input and output for said session to said second terminal.

4. The method of claim 1 wherein said step of associating comprises:
authenticating an identity of said user.

5. The method of claim 4 wherein said step of authenticating comprises:
obtaining a physical token assigned to said user.

6. The method of claim 4 wherein said step of authenticating comprises:
obtaining a passphrase.

7. The method of claim 4 wherein said step of authenticating comprises:
obtaining a biometric identifier.

8. The method of claim 7 wherein said biometric identifier is a finger print pattern.

9. The method of claim 7 wherein said biometric identifier is a retinal image.

10. The method of claim 1 wherein said step of associating comprises:
converting an initial token to said authenticated token.

11. The method of claim 10 wherein said session is identified by said authenticated token.

12. A session accessing system comprising:
an associating unit configured to associate a user with a session; and
a first presenting unit configured to present said authenticated token to access said session from a first terminal.

13. The session accessing system of claim 12 further comprising:
a second presenting unit configured to present said authenticated token to access said session from a second terminal.

14. The session accessing system of claim 13 further comprising:
a messaging unit configured to send a session disconnect signal to said first terminal; and
a routing unit configured to route input and output for said session to said second terminal.

15. The session accessing system of claim 12 wherein said associating unit comprises:
an authentication unit configured to authenticate an identity of said user.

16. The session accessing system of claim 15 wherein said authentication unit comprises:
a user interface configured to obtain a physical token assigned to said user.

17. The session accessing system of claim 15 wherein said authentication unit comprises:
a user interface configured to obtain a passphrase.

18. The session accessing system of claim 15 wherein said step of authenticating comprises:
a user interface configured to obtain a biometric identifier.

19. The session accessing system of claim 18 wherein said biometric identifier is a finger print pattern.

20. The session accessing system of claim 18 wherein said biometric identifier is a retinal image.

21. The session accessing system of claim 12 wherein said associating unit comprises:
a conversion unit configured to convert an initial token to said authenticated token.

22. The session accessing system of claim 21 wherein said session is identified by said authenticated token.

23. A computer program product comprising:
a computer usable medium having computer readable program code embodied therein configured for accessing a session, comprising:
computer readable code configured to cause a computer to associate a user with said session; and
computer readable code configured to cause a computer to present said authenticated token to access said session from a first terminal.

24. The computer program product of claim 23 further comprising:
computer readable code configured to cause a computer to present said authenticated token to access said session from a second terminal.

25. The computer program product of claim 24 further comprising:
computer readable code configured to cause a computer to send a session disconnect signal to said first terminal; and
computer readable code configured to cause a computer to route input and output for said session to said second terminal.

26. The computer program product of claim 23 wherein said computer readable code configured to cause a computer to associate comprises:
computer readable code configured to cause a computer to authenticate an identity of said user.

27. The computer program product of claim 26 wherein said computer readable code configured to cause a computer to authenticate comprises:
computer readable code configured to cause a computer to obtain a physical token assigned to said user.

28. The computer program product of claim 26 wherein said computer readable code configured to cause a computer to authenticate comprises:
computer readable code configured to cause a computer to obtain a passphrase.

29. The computer program product of claim 26 wherein said computer readable code configured to cause a computer to authenticate comprises:
computer readable code configured to cause a computer to obtain a biometric identifier.

30. The computer program product of claim 29 wherein said biometric identifier is a finger print pattern.

31. The computer program product of claim 29 wherein said biometric identifier is a retinal image.

32. The computer program product of claim 23 wherein said computer readable code configured to cause a computer to associate comprises:
computer readable code configured to cause a computer to convert an initial token to said authenticated token.

33. The computer program product of claim 32 wherein said session is identified by said authenticated token.
